(19) United States
(12) Patent Application Publication
(10) Pub. No.: US 2025/0206373 A1
(43) Pub. Date: Jun. 26, 2025

(54) STEERING CONTROL DEVICE

(71) Applicant: Hino Motors, Ltd., Hino-shi, Tokyo (JP)

(72) Inventor: Shunsuke TSUKUDA, Hino-shi (JP)

(73) Assignee: Hino Motors, Ltd., Hino-shi, Tokyo (JP)

(21) Appl. No.: 18/847,540

(22) PCT Filed: Mar. 20, 2023
(86) PCT No.: PCT/JP2023/010957

§ 371 Date: Sep. 16, 2024

(30) Foreign Application Priority Data
Mar. 24, 2022 (JP) 2022-047945

(51) Int. Cl. B62D 15/02

(52) U.S. Cl. CPC B62D 15/025

(57) ABSTRACT

A steering control device includes: a feed-forward steering angle determination unit configured to determine a feed-forward steering angle corresponding to a target yaw rate; a feedback steering angle determination unit configured to determine a feedback steering angle based on a yaw rate detected by a yaw rate sensor and a steering angle detected by a steering angle sensor; a target steering angle determination unit configured to determine a target steering angle of a vehicle based on the feed-forward steering angle and the feedback steering angle; and a correction unit configured to perform feedback steering angle fixing control for correcting the feedback steering angle output to the target steering angle determination unit to a fixed value when the yaw rate detected by the yaw rate sensor exceeds a target yaw rate range including the target yaw rate and the steering angle detected by the steering angle sensor periodically moves.

### TECHNICAL FIELD

The present disclosure relates to a steering control device.

### BACKGROUND ART

Patent Literature 1 describes a technique for decelerating a vehicle when it is detected that the vehicle is traveling on irregularities of a road surface in a lane deviation prevention device.

### CITATION LIST

### Patent Literature

Patent Literature 1: Japanese Unexamined Patent Publication No. 2005-162044

### SUMMARY OF INVENTION

### Technical Problem

Some steering control devices such as a lane deviation prevention device perform steering control of a vehicle such that a yaw rate of the vehicle detected by a yaw rate sensor becomes a target yaw rate. In such a steering control device, a target steering angle is determined based on a feed-forward steering angle corresponding to the target yaw rate, and a feedback steering angle determined based on the yaw rate detected by the yaw rate sensor and a steering angle detected by a steering angle sensor, and the steering control of the vehicle is performed based on the determined target steering angle. Here, when the vehicle passes through irregularities of a road surface, a disturbance in a vertical direction occurs in the vehicle, and the disturbance is applied to the yaw rate sensor that detects the yaw rate of the vehicle. When such a disturbance is applied to the yaw rate sensor, the yaw rate detected by the yaw rate sensor greatly deviates from the target yaw rate. Therefore, a target steering angle for reducing the deviation is determined, and the vehicle greatly turns by the steering control of the vehicle based on the determined target steering angle. Thereafter, a phenomenon occurs in which a target steering angle in a rightward turning direction and a target steering angle in a leftward turning direction are repeated in a short time so as to return a direction of the vehicle, causing the steering to periodically move in a rightward steering direction and a leftward steering direction.

Therefore, an object of the present disclosure is to provide a steering control device capable of suppressing periodic movement of steering when a vehicle passes through irregularities of a road surface.

### Solution to Problem

A steering control device according to the present disclosure is a steering control device that is mounted on a vehicle having a yaw rate sensor that detects a yaw rate and a steering angle sensor that detects a steering angle, and performs steering control of the vehicle such that the yaw rate of the vehicle becomes a target yaw rate, the steering control device including: a feed-forward steering angle determination unit configured to determine a feed-forward steering angle corresponding to the target yaw rate; a feedback steering angle determination unit configured to determine a feedback steering angle based on the yaw rate detected by the yaw rate sensor and the steering angle detected by the steering angle sensor; a target steering angle determination unit configured to determine a target steering angle of the vehicle based on the feed-forward steering angle and the feedback steering angle; and a correction unit configured to perform feedback steering angle fixing control for correcting the feedback steering angle output to the target steering angle determination unit to a fixed value when the yaw rate detected by the yaw rate sensor exceeds a target yaw rate range including the target yaw rate and the steering angle detected by the steering angle sensor periodically moves.

In this steering control device, by performing the steering control of the vehicle such that the yaw rate of the vehicle becomes the target yaw rate, for example, the vehicle can be caused to travel at a predetermined position in a lane or the vehicle can be caused to travel so as not to deviate from the lane. Then, in a case where the yaw rate detected by the yaw rate sensor exceeds the target yaw rate range and the steering angle detected by the steering angle sensor periodically moves, the feedback steering angle fixing control for correcting the feedback steering angle output to the target steering angle determination unit to the fixed value is performed, such that it is possible to suppress the periodic movement of the steering when the vehicle passes through irregularities of a road surface.

The feed-forward steering angle determination unit may set the target yaw rate based on a curvature of the lane on which the vehicle is traveling and a vehicle speed of the vehicle. In this steering control device, since the target yaw rate is set based on the curvature of the lane and the vehicle speed of the vehicle, the feed-forward steering angle can be appropriately calculated.

The feed-forward steering angle determination unit may set the target yaw rate such that the vehicle does not deviate from the lane. In this steering control device, since the target yaw rate is set such that the vehicle does not deviate from the lane, it is possible to appropriately suppress the vehicle from deviating from the lane.

The correction unit may correct the feedback steering angle to an average value of the feedback steering angles in a most recent setting period in the feedback steering angle fixing control. In this steering control device, in the feedback steering angle fixing control, the feedback steering angle is corrected to the average value of the feedback steering angles in the most recent setting period, such that it is possible to suppress a behavior of the vehicle from becoming unstable before and after the feedback steering angle fixing control.

The target steering angle determination unit may limit a displacement speed of the target steering angle when the displacement speed of the target steering angle exceeds a set speed, and the correction unit may further perform the feedback steering angle fixing control when the target steering angle determination unit limits the displacement speed of the target steering angle. In this steering control device, by limiting the displacement speed of the target steering angle when the displacement speed of the target steering angle exceeds the set speed, it is possible to suppress the behavior of the vehicle from becoming unstable. Here, when a disturbance is applied to the yaw rate sensor by the vehicle passing through the irregularities of the road surface, the displacement speed of the target steering angle tends to be excessive. Therefore, the feedback steering angle fixing control is also performed on the condition that the displacement speed of the target steering angle has been limited due to the displacement speed of the target steering angle exceeding the set speed. As a result, it is possible to more appropriately suppress the periodic movement of the steering when the vehicle passes through the irregularities of the road surface.

The target steering angle determination unit may limit a displacement speed of the target steering angle when the target steering angle exceeds a set value, and the correction unit may further perform the feedback steering angle fixing control when the target steering angle determination unit limits the displacement speed of the target steering angle. In this steering control device, by limiting the displacement speed of the target steering angle when the target steering angle exceeds the set value, it is possible to suppress the behavior of the vehicle from becoming unstable. Then, when the disturbance is applied to the yaw rate sensor by the vehicle passing through the irregularities of the road surface, the target steering angle tends to be excessive. Therefore, the feedback steering angle fixing control is also performed on the condition that the displacement speed of the target steering angle has been limited due to the target steering angle exceeding the set value. As a result, it is possible to more appropriately suppress the periodic movement of the steering when the vehicle passes through the irregularities of the road surface.

The steering control device may release the feedback steering angle fixing control when a set time has elapsed after the feedback steering angle fixing control is performed. In this steering control device, by releasing the feedback steering angle fixing control when the set time has elapsed after the feedback steering angle fixing control is performed, the feedback steering angle fixing control can be released without determining whether or not the disturbance applied to the yaw rate sensor by the vehicle passing through the irregularities of the road surface has been settled. Accordingly, the control can be simplified.

### Advantageous Effects of Invention

According to the present disclosure, it is possible to suppress periodic movement of steering when a vehicle passes through irregularities of a road surface.

### BRIEF DESCRIPTION OF DRAWINGS

FIG. 1 is a schematic diagram illustrating a steering control device according to a first embodiment.

FIG. 2 is a graph illustrating an example of a relationship between a time and a target steering angle.

FIG. 3 is a graph illustrating an example of a relationship between a time and a yaw rate.

FIG. 4 is a graph illustrating an example of a relationship between a time and a feedback steering angle determined by a feedback steering angle determination unit.

FIG. 5 is a graph illustrating an example of a relationship between a time and a feedback steering angle corrected by a correction unit.

FIG. 6 is a flowchart illustrating an example of a processing operation of the steering control device according to the first embodiment.

FIG. 7 is a schematic diagram illustrating a steering control device according to a second embodiment.

FIG. 8 is a flowchart illustrating an example of a processing operation of the steering control device according to the second embodiment.

### DESCRIPTION OF EMBODIMENTS

Hereinafter, embodiments of the present disclosure will be described in detail with reference to the drawings. In the following description, the same or corresponding elements are denoted by the same reference numerals, and redundant description is omitted.

### First Embodiment

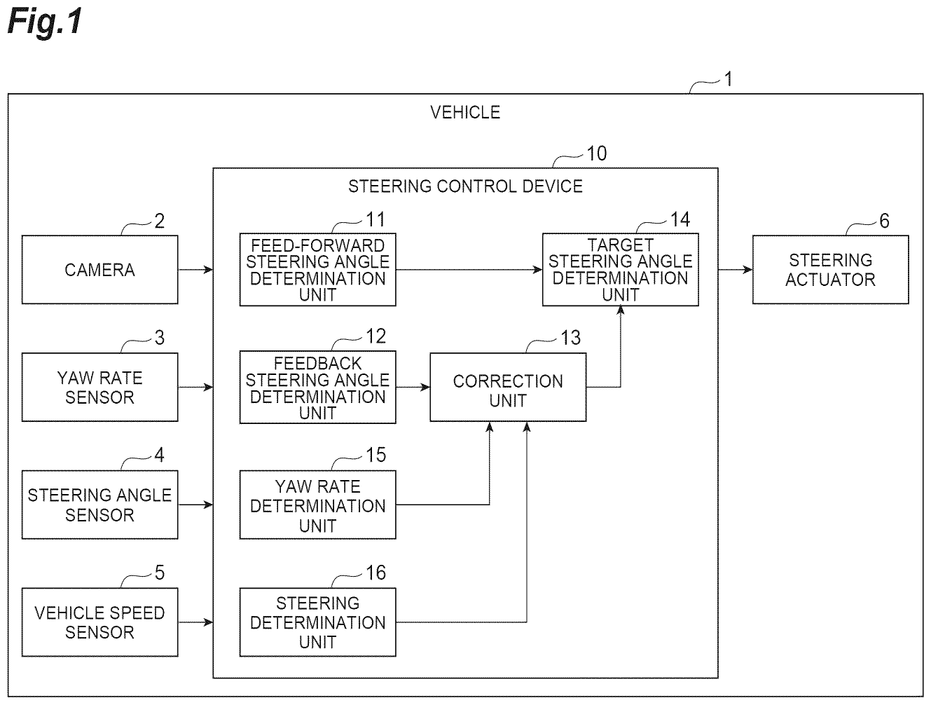

FIG. 1 is a schematic diagram illustrating a steering control device 10 according to a first embodiment. As illustrated in FIG. 1, the steering control device 10 according to the present embodiment is mounted on a vehicle 1 and performs steering control of the vehicle 1. For example, the steering control device 10 performs steering control of the vehicle 1 such that the vehicle 1 does not deviate from a lane or the vehicle 1 travels at a predetermined position in a vehicle width direction of the lane.

The vehicle 1 includes a camera 2, a yaw rate sensor 3, a steering angle sensor 4, a vehicle speed sensor 5, a steering actuator 6, and the steering control device 10.

The camera 2 images a front of the vehicle 1. The camera 2 may be a monocular camera or a stereo camera. The stereo camera has two imaging units disposed to reproduce binocular parallax. Imaging information of the stereo camera also includes information in a depth direction. The camera 2 outputs the captured image to the steering control device 10.

The yaw rate sensor 3 detects a yaw rate y of the vehicle 1. The yaw rate y is a rotational angular velocity around a vertical axis of the vehicle 1. For example, a gyro sensor is used as the yaw rate sensor 3. The yaw rate sensor 3 outputs information indicating the detected yaw rate y of the vehicle 1 to the steering control device 10.

The steering angle sensor 4 detects a steering angle (a rotation amount of a steering shaft) of the vehicle 1. The steering angle sensor 4 outputs information indicating the detected steering angle of the vehicle 1 to the steering control device 10.

The vehicle speed sensor 5 detects a vehicle speed (speed) of the vehicle 1. As the vehicle speed sensor 5, for example, a wheel speed sensor that is provided on a drive shaft of the vehicle 1 and detects a rotation speed of a wheel is used. The vehicle speed sensor 5 outputs information indicating the detected vehicle speed of the vehicle 1 to the steering control device 10.

The steering actuator 6 controls driving of an electric power steering system in accordance with a control signal from the steering control device 10. The steering angle of the vehicle 1 is controlled by controlling the driving of the electric power steering system.

The steering control device 10 is, for example, an electronic control unit (ECU) having a central processing unit (CPU), a read only memory (ROM), a random access memory (RAM), and the like. In the steering control device 10, for example, a program stored in the ROM is loaded into the RAM and executed by the CPU to execute various controls. The steering control device 10 may be configured by a single electronic control unit or may be configured by a plurality of electronic control units.

The steering control device 10 performs steering control of the vehicle 1 such that the yaw rate γ of the vehicle 1 becomes a target yaw rate γ_{T}. The steering control device 10 includes, as a functional configuration, a feed-forward steering angle determination unit 11, a feedback steering angle determination unit 12, a correction unit 13, a target steering angle determination unit 14, a yaw rate determination unit 15, and a steering determination unit 16.

The feed-forward steering angle determination unit 11 determines a feed-forward steering angle corresponding to the target yaw rate γ_{T}. For example, the feed-forward steering angle determination unit 11 sets the target yaw rate γ_{T}, determines the target yaw rate γ_{T} based on a curvature of the lane on which the vehicle 1 is traveling and the vehicle speed of the vehicle 1, and determines the feed-forward steering angle corresponding to the target yaw rate γ_{T}. Then, the feed-forward steering angle determination unit 11 outputs the determined feed-forward steering angle to the target steering angle determination unit 14.

The curvature of the lane on which the vehicle 1 is traveling is acquired by analyzing the captured image captured by the camera 2. Note that the curvature of the lane on which the vehicle 1 is traveling may be acquired by identifying a position of the vehicle 1 by GPS or the like and comparing the identified position of the vehicle 1 with map information. The vehicle speed of the vehicle 1 is acquired from the vehicle speed sensor 5. The target yaw rate γ_{T} may be, for example, a yaw rate for causing the vehicle 1 to travel in a center in a width direction of the lane, or may be a yaw rate for returning the vehicle 1 to a center side in the width direction of the lane so that the vehicle 1 does not deviate from the lane when the vehicle 1 is about to deviate from the lane. The feed-forward steering angle is a steering angle for setting the yaw rate γ of the vehicle 1 to the target yaw rate γ_{T}.

The feedback steering angle determination unit 12 determines a feedback steering angle based on the yaw rate γ of the vehicle 1 detected by the yaw rate sensor 3 and the steering angle of the vehicle 1 detected by the steering angle sensor 4. For example, the feedback steering angle determination unit 12 determines, as the feedback steering angle, a difference between a steering angle corresponding to the yaw rate γ of the vehicle 1 detected by the yaw rate sensor 3 and a steering angle corresponding to the target yaw rate γ_{T}. Then, the feedback steering angle determination unit 12 outputs the determined feedback steering angle to the correction unit 13.

The correction unit 13 corrects the feedback steering angle output from the feedback steering angle determination unit 12 as necessary and outputs the corrected feedback steering angle to the target steering angle determination unit 14. Note that details of the correction unit 13 will be described later.

The target steering angle determination unit 14 determines a target steering angle of the vehicle 1 based on the feed-forward steering angle and the feedback steering angle. For example, the target steering angle determination unit 14 sets, as the target steering angle, a steering angle obtained by combining the feed-forward steering angle determined by the feed-forward steering angle determination unit 11 and the feedback steering angle determined by the feedback steering angle determination unit 12. In addition, when the feedback steering angle is corrected by the correction unit 13, a steering angle obtained by combining the feed-forward steering angle determined by the feed-forward steering angle determination unit 11 and the feedback steering angle corrected by the correction unit 13 is set as the target steering angle. Then, the target steering angle determination unit 14 performs steering control of the vehicle 1 by performing driving control of the steering actuator 6 based on the determined target steering angle.

By the way, in a case where a displacement speed of the target steering angle becomes excessive, when the steering control of the vehicle 1 is performed with the target steering angle as it is, there is a possibility that a behavior of the vehicle 1 becomes unstable. The displacement speed of the target steering angle is a displacement amount of the target steering angle per unit. Similarly, in a case where the target steering angle becomes excessive, when the steering control of the vehicle 1 is performed with the target steering angle as it is, there is a possibility that the behavior of the vehicle 1 becomes unstable.

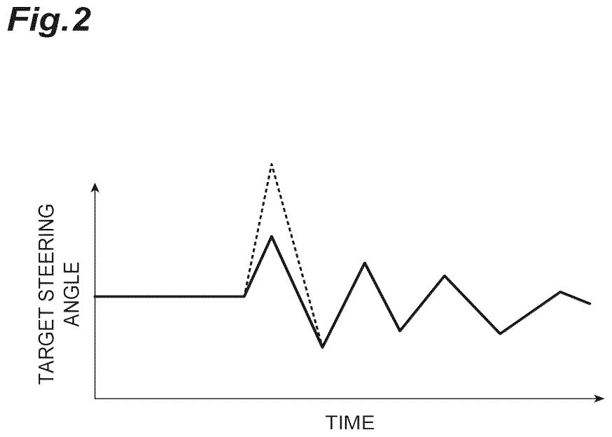

Therefore, as illustrated in FIG. 2, the target steering angle determination unit 14 limits the displacement speed of the target steering angle when the displacement speed of the target steering angle exceeds a set speed or when the target steering angle exceeds a set value. FIG. 2 is a graph illustrating an example of a relationship between a time and a target steering angle. In FIG. 2, a broken line indicates a target steering angle when a displacement speed is not limited, and a solid line indicates a target steering angle when a displacement speed is limited. The set speed of the change speed of the target steering angle and the set value of the target steering angle, which are conditions for limiting the displacement speed of the target steering angle, are not particularly limited. For example, the set speed of the change speed of the target steering angle can be set to a speed within a range in which the behavior of the vehicle 1 does not become unstable when the steering control of the vehicle 1 is performed based on the target steering angle. Similarly, the set value of the target steering angle can be a value within a range in which the behavior of the vehicle 1 does not become unstable when the steering control of the vehicle 1 is performed based on the target steering angle. The displacement speed of the target steering angle can be easily obtained, for example, by recording a past target steering angle.

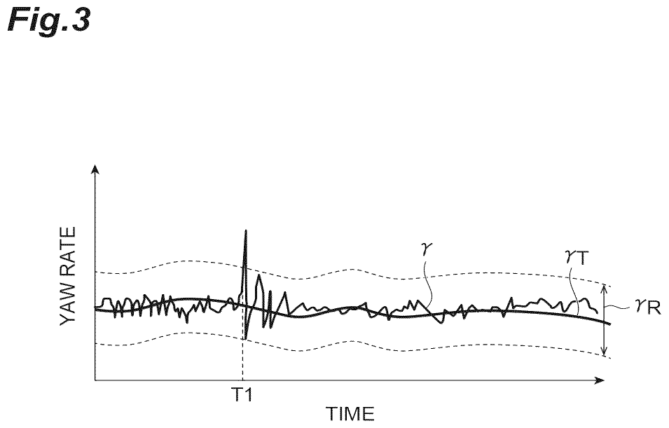

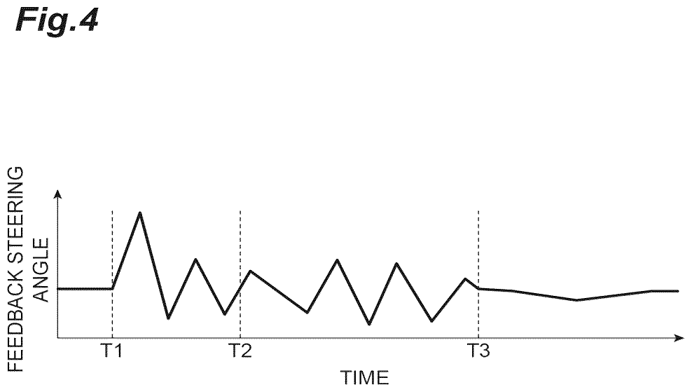

Here, a state when the vehicle 1 passes through irregularities of a road surface will be described with reference to FIGS. 3 and 4. FIG. 3 is a graph illustrating an example of a relationship between a time and a yaw rate. FIG. 4 is a graph illustrating an example of a relationship between a time and a feedback steering angle determined by the feedback steering angle determination unit. In FIGS. 3 and 4, a timing at which the vehicle 1 passes through the irregularities of the road surface is indicated by a time T1. FIG. 4 illustrates an example of a relationship between a time and a feedback steering angle in a part of a time zone in

FIG. 3. The irregularities of the road surface are, for example, irregularities such as a joint, a rumble strip, or a pebble, in which the vehicle 1 swings in a vertical direction by the vehicle 1 passing therethrough.

As illustrated in FIGS. 3 and 4, when the vehicle 1 passes through the irregularities and a disturbance in the vertical direction occurs in the vehicle 1, the disturbance (impact) is also applied to the yaw rate sensor 3, and the yaw rate γ detected by the yaw rate sensor 3 rapidly increases to a positive side (or a negative side). As a result, since the feedback steering angle determined by the feedback steering angle determination unit 12 also rapidly increases to the positive side (or the negative side), the target steering angle determination unit 14 determines a target steering angle such that the steering greatly moves in a leftward steering direction (or a rightward steering direction), and performs driving control of the steering actuator 6. As a result, the vehicle 1 starts turning left (or turning right). Then, the yaw rate sensor 3 detects the yaw rate γ on the negative side (or the positive side), which is the opposite direction to the direction when the vehicle 1 passes through the irregularities. As a result, the feedback steering angle determination unit 12 determines the feedback steering angle on the negative side (or the positive side), and the target steering angle determination unit 14 determines the target steering angle such that the steering moves in the rightward steering direction (or the leftward steering direction) and performs driving control of the steering actuator 6. That is, the target steering angle determination unit 14 determines the target steering angle so as to return the direction of the vehicle 1 that has turned due to the passage of the irregularities, and performs driving control of the steering actuator 6. Then, a phenomenon occurs in which such a processing operation is repeated in a short time, causing the steering to periodically move. The periodic movement of the steering means that the steering repeats a movement in a right steering (right rotation) direction and a movement in a left steering (left rotation) direction in a short time.

The yaw rate determination unit 15 determines whether or not the yaw rate γ detected by the yaw rate sensor 3 has exceeded a target yaw rate range γ_{R} including the target yaw rate γ_{T}. The target yaw rate range γ_{R} is a range from a yaw rate smaller than the target yaw rate γ_{T} to a yaw rate larger than the target yaw rate γ_{T}. An upper limit value and a lower limit value of the target yaw rate range γ_{R} are not particularly limited. For example, the target yaw rate range γ_{R} can be set to a range that includes a yaw rate γ detected by the yaw rate sensor 3 when no disturbance is applied to the yaw rate sensor 3 and does not include a yaw rate γ detected by the yaw rate sensor 3 when a disturbance is applied to the yaw rate sensor 3 by the vehicle 1 passing through the irregularities of the road surface.

The steering determination unit 16 determines whether or not the steering angle detected by the steering angle sensor 4 is periodically moving, that is, whether or not the steering is periodically moving. When the steering angle detected by the steering angle sensor 4 is repeatedly switched in a short time between the rightward steering direction (positive direction) and the leftward steering direction (negative direction), the steering determination unit 16 determines that the steering angle detected by the steering angle sensor 4 is periodically moving, that is, the steering is periodically moving.

The correction unit 13 determines whether or not the yaw rate γ detected by the yaw rate sensor 3 exceeds the target yaw rate range γ_{R} including the target yaw rate γ_{T} and the steering angle detected by the steering angle sensor 4 periodically moves. Whether or not the yaw rate γ detected by the yaw rate sensor 3 exceeds the target yaw rate range γ_{R} including the target yaw rate γ_{T} is determined based on the determination result of the yaw rate determination unit 15. Whether or not the steering angle detected by the steering angle sensor 4 periodically moves is determined based on the determination result of the steering determination unit 16. Then, the correction unit 13 performs feedback steering angle fixing control when the yaw rate γ detected by the yaw rate sensor 3 exceeds the target yaw rate range γ_{R} including the target yaw rate γ_{T} and the steering angle detected by the steering angle sensor 4 periodically moves. The feedback steering angle fixing control is control for correcting the feedback steering angle output to the target steering angle determination unit 14 to a fixed value. In addition, the correction unit 13 releases the feedback steering angle fixing control when a set time has elapsed after the feedback steering angle fixing control is performed (after starting the feedback steering angle fixing control).

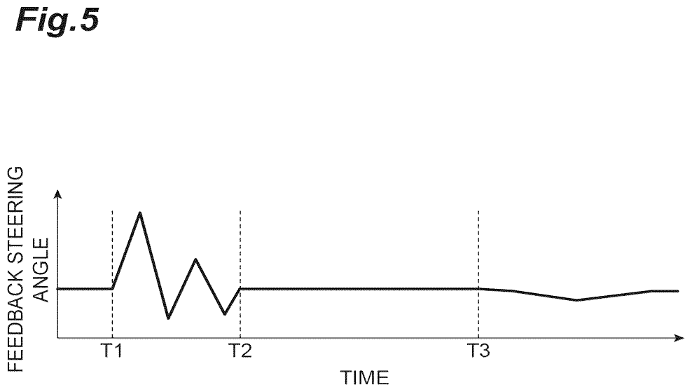

FIG. 5 is a graph illustrating an example of a relationship between a time and a feedback steering angle corrected by the correction unit. In FIGS. 4 and 5, a timing at which the feedback steering angle fixing control is started is indicated by a time T2, and a timing at which the feedback steering angle fixing control is released is indicated by a time T3. When the feedback steering angle fixing control is not executed (before execution and after release of the feedback steering angle fixing control), the correction unit 13 outputs the feedback steering angle output from the feedback steering angle determination unit 12 to the target steering angle determination unit 14 as it is. Therefore, the target steering angle determination unit 14 determines the target steering angle based on the feedback steering angle determined by the feedback steering angle determination unit 12. On the other hand, as illustrated in FIG. 5, during the execution of the feedback steering angle fixing control, the correction unit 13 corrects the feedback steering angle output from the feedback steering angle determination unit 12 to a fixed value and outputs the corrected value to the target steering angle determination unit 14. Therefore, the target steering angle determination unit 14 does not determine the target steering angle based on the feedback steering angle determined by the feedback steering angle determination unit 12, but determines the target steering angle based on the feedback steering angle corrected to the fixed value by the correction unit 13.

The fixed value that is the correction value of the feedback steering angle is not particularly limited. For example, the fixed value that is the correction value of the feedback steering angle may be an average value of the feedback steering angles in a most recent setting period of the feedback steering angle fixing control, or may be a most recent feedback steering angle of the feedback steering angle fixing control. The setting period is not particularly limited, but may be, for example, about three seconds. Note that the average value of the feedback steering angles in the most recent setting period of the feedback steering angle fixing control can be easily obtained, for example, by recording the past feedback steering angle.

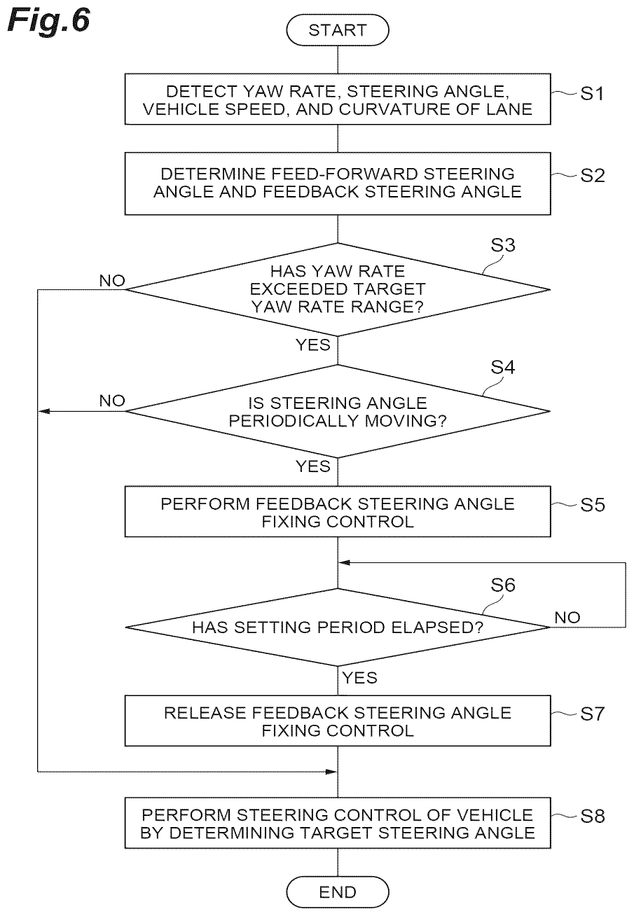

Next, an example of a processing operation of the steering control device 10 will be described with reference to FIG. 6. FIG. 6 is a flowchart illustrating an example of the processing operation of the steering control device according to the first embodiment.

As illustrated in FIG. 6, first, the steering control device 10 detects a yaw rate γ of the vehicle 1 by the yaw rate sensor 3, detects a steering angle of the vehicle 1 by the steering angle sensor 4, detects a vehicle speed of the vehicle 1 by the vehicle speed sensor 5, and detects a curvature of the lane on which the vehicle 1 is traveling (step S1). The order of these detections is not particularly limited, and these detections may be performed in any order, or some or all of them may be performed simultaneously.

Next, the steering control device 10 determines a feed-forward steering angle and a feedback steering angle (step S2). Then, the steering control device 10 determines whether or not the yaw rate γ detected by the yaw rate sensor 3 has exceeded a target yaw rate range γ_{R} (step S3). When it is determined that the yaw rate γ detected by the yaw rate sensor 3 does not exceed the target yaw rate range γ_{R} (step S3: NO), the steering control device 10 determines a target steering angle based on the feed-forward steering angle determined in step S2 and the feedback steering angle determined in step S2, and performs steering control of the vehicle 1 at the determined target steering angle (step S8). When the displacement speed of the target steering angle determined in step S8 exceeds a set speed or when the target steering angle determined in step S8 exceeds a set value, the steering control device 10 limits a displacement speed of the target steering angle. Then, the steering control device 10 temporarily ends the processing and repeats the processing from step S1 again.

When it is determined that the yaw rate γ detected by the yaw rate sensor 3 has exceeded the target yaw rate range γ_{R} (step S3: YES), the steering control device 10 determines whether or not the steering angle detected by the steering angle sensor 4 is periodically moving (step S4). Note that steps S3 and S4 may be performed in the reverse order or may be performed simultaneously. When it is determined that the steering angle detected by the steering angle sensor 4 does not periodically move (step S4: NO), the steering control device 10 determines a target steering angle based on the feed-forward steering angle determined in step S2 and the feedback steering angle determined in step S2, and performs steering control of the vehicle 1 at the determined target steering angle (step S8). Then, the steering control device 10 temporarily ends the processing and repeats the processing from step S1 again.

When it is determined that the steering angle detected by the steering angle sensor 4 is periodically moving (step S4: YES), the steering control device 10 performs feedback steering angle fixing control for correcting the feedback steering angle output to the target steering angle determination unit 14 to a fixed value (step S5). In step S5, the steering control device 10 determines a target steering angle based on the feed-forward steering angle determined in step S2 and the feedback steering angle corrected to the fixed value, and performs steering control of the vehicle 1 at the determined target steering angle. Then, the steering control device 10 continues the feedback steering angle fixing control until a setting period has elapsed after the feedback steering angle fixing control is performed (step S6).

When the setting period has elapsed after the feedback steering angle fixing control is performed (step S6: YES), the steering control device 10 releases the feedback steering angle fixing control (step S7), determines a target steering angle based on the feed-forward steering angle determined in step S2 and the feedback steering angle determined in step S2, and performs steering control of the vehicle 1 with the determined target steering angle (step S8). Then, the steering control device 10 temporarily ends the processing and repeats the processing from step S1 again.

As described above, in the steering control device 10 according to the present embodiment, by performing the steering control of the vehicle 1 so that the yaw rate γ of the vehicle 1 becomes the target yaw rate γ_{T}, for example, the vehicle 1 can be caused to travel at a predetermined position in the lane or the vehicle 1 can be caused to travel so as not to deviate from the lane. Then, in a case where the yaw rate γ detected by the yaw rate sensor 3 exceeds the target yaw rate range γ_{R} and the steering angle detected by the steering angle sensor 4 periodically moves, the feedback steering angle fixing control for correcting the feedback steering angle output to the target steering angle determination unit 14 to the fixed value is performed, such that it is possible to suppress the periodic movement of the steering when the vehicle 1 passes through the irregularities of the road surface.

In addition, in the steering control device 10, since the target yaw rate γ_{T} is set based on the curvature of the lane and the vehicle speed of the vehicle 1, the feed-forward steering angle can be appropriately calculated.

In addition, in the steering control device 10, since the target yaw rate γ_{T} is set such that the vehicle 1 does not deviate from the lane, it is possible to appropriately suppress the vehicle 1 from deviating from the lane.

In addition, in the steering control device 10, in the feedback steering angle fixing control, the feedback steering angle is corrected to the average value of the feedback steering angles in the most recent setting period, it is possible to suppress the behavior of the vehicle 1 from becoming unstable.

In addition, in the steering control device 10, by limiting the displacement speed of the target steering angle when the displacement speed of the target steering angle exceeds the set speed, it is possible to suppress the behavior of the vehicle 1 from becoming unstable.

In addition, in the steering control device 10, by limiting the displacement speed of the target steering angle when the target steering angle exceeds the set value, it is possible to suppress the behavior of the vehicle 1 from becoming unstable.

In addition, in the steering control device 10, when the set time has elapsed after the feedback steering angle fixing control is performed, the feedback steering angle fixing control is released, such that the feedback steering angle fixing control can be released without determining whether or not the disturbance applied to the yaw rate sensor 3 by the vehicle 1 passing through the irregularities of the road surface has been settled. Accordingly, the control can be simplified.

### Second Embodiment

Next, a second embodiment of the present disclosure will be described. The second embodiment is basically similar to the first embodiment, but is different from the first embodiment in the content of the feedback steering angle fixing control by the steering control unit. Therefore, only matters different from those of the first embodiment will be described below, and description of the same matters as those of the first embodiment will be omitted.

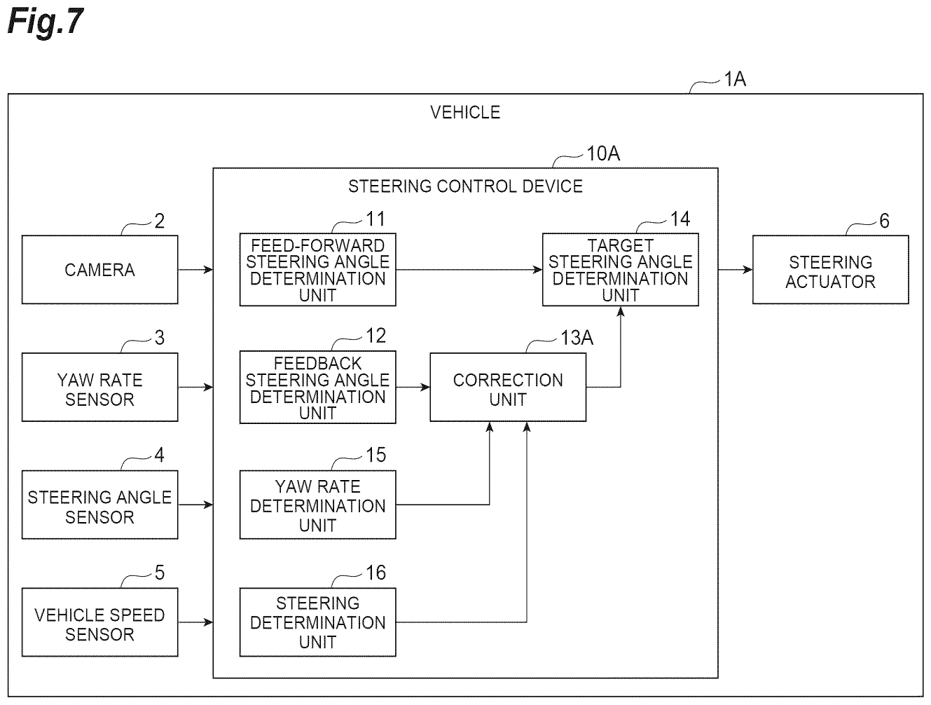

FIG. 7 is a schematic diagram illustrating a steering control device according to a second embodiment. As illustrated in FIG. 7, a steering control device 10A according to the present embodiment is mounted on a vehicle 1A and performs steering control of the vehicle 1A. The steering control device 10A includes a camera 2, a yaw rate sensor 3, a steering angle sensor 4, a vehicle speed sensor 5, a steering actuator 6, and the steering control device 10A.

The steering control device 10A includes, as a functional configuration, a feed-forward steering angle determination unit 11, a feedback steering angle determination unit 12, a correction unit 13A, a target steering angle determination unit 14, a yaw rate determination unit 15, and a steering determination unit 16.

The correction unit 13A is basically similar to the correction unit 13A of the first embodiment, and differs from the correction unit 13 of the first embodiment in a part of the condition for performing the feedback steering angle fixing control. Similarly to the first embodiment, the target steering angle determination unit 14 limits a displacement speed of a target steering angle when the displacement speed of the target steering angle exceeds a set speed or when a target steering angle exceeds a set value. Then, when a yaw rate γ detected by the yaw rate sensor 3 exceeds a target yaw rate range γ_{R} including a target yaw rate γ_{T}, a steering angle detected by the steering angle sensor 4 periodically moves, and then the target steering angle determination unit 14 limits the displacement speed of the target steering angle, the correction unit 13A performs feedback steering angle fixing control for correcting the feedback steering angle output to the target steering angle determination unit 14 to a fixed value. That is, in addition to the condition under which the correction unit 13 of the first embodiment performs the feedback steering angle fixing control, the correction unit 13A performs the feedback steering angle fixing control on the condition that the displacement speed of the target steering angle has been limited due to the displacement speed of the target steering angle exceeding the set speed or due to the target steering angle exceeding the set value.

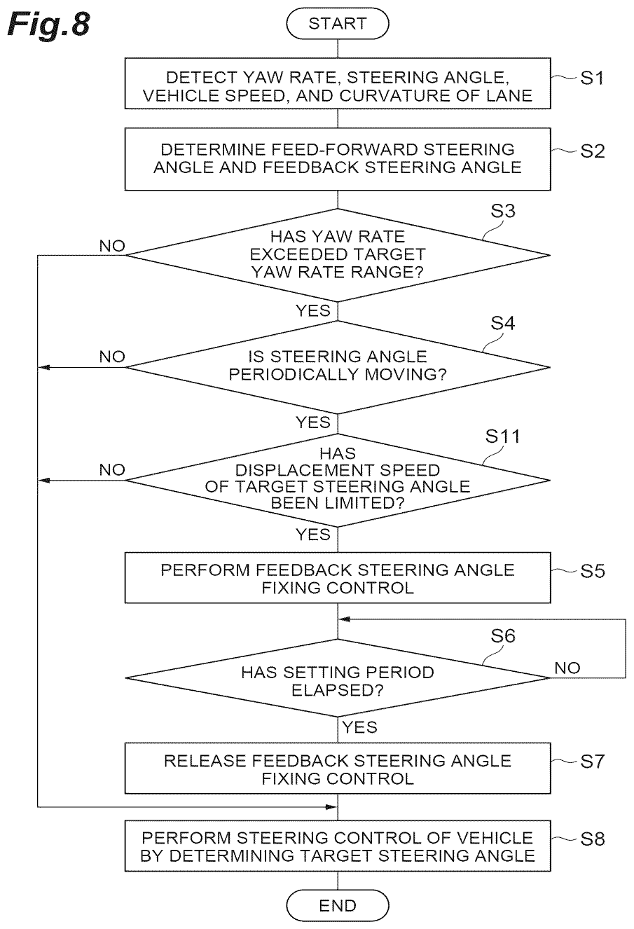

Next, an example of a processing operation of the steering control device 10A will be described with reference to FIG. 8. FIG. 8 is a flowchart illustrating an example of the processing operation of the steering control device according to the second embodiment.

As illustrated in FIG. 8, first, the steering control device 10A performs steps S1 to S4 as in the first embodiment. Then, when it is determined in step S4 that the steering angle detected by the steering angle sensor 4 is periodically moving (step S4: YES), the steering control device 10A determines whether or not a displacement speed of the target steering angle has been limited due to the displacement speed of the target steering angle determined in step S8 up to the previous time exceeding a set speed or due to the target steering angle determined in step S8 up to the previous time exceeding a set value (step S11). Then, when it is determined that the displacement speed of the target steering angle has not been limited (step S11: NO), the steering control device 10A determines the target steering angle based on the feed-forward steering angle and the feedback steering angle determined in step S2, and performs steering control of the vehicle 1 with the determined target steering angle (step S8). Then, the steering control device 10A temporarily ends the processing and repeats the processing from step S1 again.

When it is determined that the displacement speed of the target steering angle has been limited (step S11: YES), the steering control device 10A performs feedback steering angle fixing control for correcting the feedback steering angle output to the target steering angle determination unit 14 to a fixed value (step S5). Then, the steering control device 10A performs steps S6 to S8 similarly to the first embodiment.

As described above, in the steering control device 10A according to the present embodiment, when a disturbance is applied to the yaw rate sensor 3 by the vehicle 1 passing through the irregularities of the road surface, the displacement speed of the target steering angle tends to be excessive. Therefore, the feedback steering angle fixing control is also performed on the condition that the displacement speed of the target steering angle has been limited due to the displacement speed of the target steering angle exceeding the set speed. As a result, it is possible to more appropriately suppress the periodic movement of the steering when the vehicle 1 passes through the irregularities of the road surface.

In addition, in the steering control device 10A, when the disturbance is applied to the yaw rate sensor 3 by the vehicle 1 passing through the irregularities of the road surface, the target steering angle tends to be excessive. Therefore, the feedback steering angle fixing control is also performed on the condition that the displacement of the target steering angle has been limited due to the target steering angle exceeding the set value. As a result, it is possible to more appropriately suppress the periodic movement of the steering when the vehicle 1 passes through the irregularities of the road surface.

Although the embodiments of the present disclosure have been described above, the present disclosure is not limited to the above embodiments, and may be modified or applied to other things without changing the gist described in each claim.

For example, in the above embodiments, it has been described that a steering control unit limits a displacement speed of a target steering angle when the displacement speed of the target steering angle exceeds a set speed or when the target steering angle exceeds a set value. However, even in such a case, the steering control unit may be configured not to limit the displacement speed of the target steering angle. In such a case, instead of limiting the displacement speed of the target steering angle, a correction unit or the like may perform correction to limit a displacement speed of a feedback steering angle output to a target steering angle determination unit.

### REFERENCE SIGNS LIST

1 Vehicle
1A Vehicle
2 Camera
3 Yaw rate sensor
4 Steering angle sensor
5 Vehicle speed sensor
6 Steering actuator
10 Steering control device
10A Steering control device
11 Feed-forward steering angle determination unit
12 Feedback steering angle determination unit
13 Correction unit
13A Correction unit
14 Target steering angle determination unit
15 Yaw rate determination unit
16 Steering determination unit
γ Yaw rate
γ_{R} Target yaw rate range
γ_{T} Target yaw rate

1. A steering control device that is mounted on a vehicle having a yaw rate sensor that detects a yaw rate and a steering angle sensor that detects a steering angle, and performs steering control of the vehicle such that the yaw rate of the vehicle becomes a target yaw rate, the steering control device comprising:
a feed-forward steering angle determination unit configured to determine a feed-forward steering angle corresponding to the target yaw rate;
a feedback steering angle determination unit configured to determine a feedback steering angle based on the yaw rate detected by the yaw rate sensor and the steering angle detected by the steering angle sensor;
a target steering angle determination unit configured to determine a target steering angle of the vehicle based on the feed-forward steering angle and the feedback steering angle; and
a correction unit configured to perform feedback steering angle fixing control for correcting the feedback steering angle output to the target steering angle determination unit to a fixed value when the yaw rate detected by the yaw rate sensor exceeds a target yaw rate range including the target yaw rate and the steering angle detected by the steering angle sensor periodically moves.

2. The steering control device according to claim 1, wherein
the feed-forward steering angle determination unit sets the target yaw rate based on a curvature of a lane on which the vehicle is traveling and a vehicle speed of the vehicle.

3. The steering control device according to claim 2, wherein
the feed-forward steering angle determination unit sets the target yaw rate such that the vehicle does not deviate from the lane.

4. The steering control device according to claim 1, wherein
the correction unit corrects the feedback steering angle to an average value of the feedback steering angles in a most recent setting period in the feedback steering angle fixing control.

5. The steering control device according to claim 1, wherein
the target steering angle determination unit limits a displacement speed of the target steering angle when the displacement speed of the target steering angle exceeds a set speed, and
the correction unit further performs the feedback steering angle fixing control when the target steering angle determination unit limits the displacement speed of the target steering angle.

6. The steering control device according to claim 1, wherein
the target steering angle determination unit limits a displacement speed of the target steering angle when the target steering angle exceeds a set value, and
the correction unit further performs the feedback steering angle fixing control when the target steering angle determination unit limits the displacement speed of the target steering angle.

7. The steering control device according to claim 1, wherein
the steering control device releases the feedback steering angle fixing control when a set time elapses after the feedback steering angle fixing control is performed.
